(19) United States
(12) Patent Application Publication
(10) Pub. No.: US 2026/0055262 A1
(43) Pub. Date: Feb. 26, 2026

(54) RUBBER COMPOSITION FOR TIRES

(71) Applicant: THE YOKOHAMA RUBBER CO., LTD., Kanagawa (JP)

(72) Inventor: Keisuke MURASE, Kanagawa (JP)

(21) Appl. No.: 19/102,686

(22) PCT Filed: Aug. 10, 2023
(86) PCT No.: PCT/JP2023/029302

§ 371 Date: Feb. 10, 2025

(30) Foreign Application Priority Data
Aug. 15, 2022 (JP) 2022-129188

(51) Int. Cl. C08L 9/06; B60C 1/00; C08K 3/36; C08K 5/548; C08L 93/00

(52) U.S. Cl. CPC C08L 9/06; B60C 1/0016; C08K 3/36; C08K 5/548; C08L 93/00; C08L 2205/025; C08L 2205/035

(57) ABSTRACT

A rubber composition for a tire contains from 50 to 150 parts by mass of silica and from 10 to 80 parts by mass of a thermoplastic resin that are blended per 100 parts by mass of a diene rubber consisting of a styrene-butadiene rubber (A), a styrene-butadiene rubber (B), and a butadiene rubber, in 100 mass % of the diene rubber, the butadiene rubber being in an amount of 30 mass % or more, the styrene-butadiene rubber (A) being in an amount of from 15 to 35 mass %, and the styrene-butadiene rubber (B) being in an amount from once to twice a mass of the styrene-butadiene rubber (A), the styrene-butadiene rubber (A) having a glass transition temperature of from −75° C. to −50° C., and the styrene-butadiene rubber (B) having a weight average molecular weight that is 2 or more times a weight average molecular weight of the styrene-butadiene rubber (A).

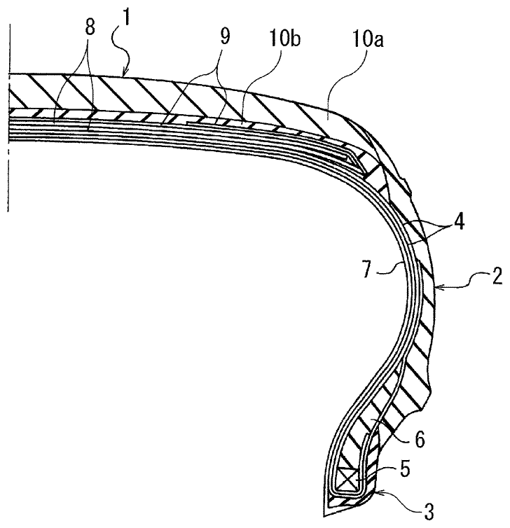

### TECHNICAL FIELD

The present technology relates to a rubber composition for a tire, the rubber composition providing excellent wear resistance, wet performance, and forming processability.

### BACKGROUND ART

Tires for the north American market are required to provide high levels of wear resistance and wet performance in a compatible manner. An attempt to improve wet performance by using a diene rubber with a high glass transition temperature in a rubber composition for forming a tread results in reduced wear resistance, making it difficult to obtain a tire that provides both properties in a compatible manner. Moreover, an attempt to improve wear resistance by using a high molecular weight diene rubber results in increased viscosity of a rubber composition and deteriorated forming processability. On the contrary, an attempt to reduce viscosity by using a low molecular weight diene rubber results in a problem of reduced wear resistance.

To provide good wet skid resistance, low rolling resistance, and wear characteristics, Japan Unexamined Patent Publication No. 2021-021070 A proposes a pneumatic tire having a tread including a vulcanizable rubber composition containing: (A) from about 20 to about 100 phr of a solution-polymerized styrene-butadiene rubber with a glass transition temperature (Tg) of from −85° C. to −50° C.; (B) from 0 to about 40 phr of natural rubber or synthetic polyisoprene; (C) from 0 to about 30 phr of cis-1,4-polybutadiene with a Tg of from −110° C. to −90° C.; (D) from 0 to 50 phr of a process oil; (E) from 20 to 80 phr of a hydrocarbon resin with a Tg of at least 30° C.; and (F) from 90 to 150 phr of silica.

However, the technology described in Japan Unexamined Patent Publication No. 2021-021070 A has not necessarily achieved a sufficient effect in providing high levels of wear resistance and wet performance in a compatible manner and providing excellent forming processability.

### SUMMARY

The present technology provides a rubber composition for a tire, the rubber composition providing high levels of wear resistance and wet performance in a compatible manner and having low viscosity and good forming processability.

A rubber composition for a tire according to the present technology may contain from 50 to 150 parts by mass of silica and from 10 to 80 parts by mass of a thermoplastic resin that are blended per 100 parts by mass of a diene rubber consisting of a styrene-butadiene rubber (A), a styrene-butadiene rubber (B), and a butadiene rubber,
in 100 mass % of the diene rubber,
the butadiene rubber being in an amount of 30 mass % or more,
the styrene-butadiene rubber (A) being in an amount of from 15 to 35 mass %,
the styrene-butadiene rubber (B) being in an amount from once to twice a mass of the styrene-butadiene rubber (A),
the styrene-butadiene rubber (A) having a glass transition temperature of from −75° C. to −50° C., and
the styrene-butadiene rubber (B) having a weight average molecular weight that is 2 or more times a weight average molecular weight of the styrene-butadiene rubber (A).

The rubber composition for a tire according to an embodiment of the present technology has the above composition, thus can provide high levels of wear resistance and wet performance in a compatible manner and have e low viscosity and good forming processability.

Preferably, the weight average molecular weight of the styrene-butadiene rubber (A) is from 300000 to 600000. Preferably, the styrene-butadiene rubber (B) has a glass transition temperature of lower than −30° C.

Preferably, the thermoplastic resin has a glass transition temperature of from 40° C. to 120° C. and is at least one selected from the group consisting of a resin composed of at least one selected from a terpene, a modified terpene, a rosin, a rosin ester, a C5 component, and a C9 component, and a resin with at least some of double bonds of the resin being hydrogenated.

Preferably, the rubber composition for a tire further contains a liquid polymer.

A tire including a tread portion made of the rubber composition for a tire described above has high levels of wear resistance and wet performance in a compatible manner, and high quality tires with good forming processability can be stably produced.

### BRIEF DESCRIPTION OF DRAWINGS

The Drawing is a cross-sectional view in a tire meridian direction illustrating an embodiment of a tire formed using a rubber composition for a tire according to an embodiment of the present technology.

### DETAILED DESCRIPTION

A rubber composition for a tire according to an embodiment of the present technology can be suitably used in a tread portion and/or a side portion of a tire. The tire may be a pneumatic tire or a non-pneumatic tire. The Drawing is a cross-sectional view illustrating an example of an embodiment of a pneumatic tire. The pneumatic tire includes a tread portion 1, a side portion 2, and a bead portion 3.

In the Drawing, two carcass layers 4 are extended between the left part and right part of a bead portion 3. In the two carcass layers 4, reinforcing cords extending in the tire radial direction are arranged at a predetermined interval in the tire circumferential direction and embedded in a rubber layer. Both end portions of the two carcass layers 4 are folded back from the inner side to the outer side in the tire axial direction around a bead core 5 embedded in the bead portion 3 so as to sandwich a bead filler 6. In the inner side of the carcass layers 4, an innerliner layer 7 is disposed. On the outer circumferential side of the carcass layers 4 of the tread portion 1, two belt layers 8 are disposed. In the belt layers 8, reinforcing cords inclined and extending in the tire circumferential direction are arranged at a predetermined interval in the tire axial direction and embedded in the rubber layer. The reinforcing cords of the two belt layers 8 are arranged in the opposite directions to each other and intersect between the layers with the inclination directions relative to the tire circumferential direction, that is, the cord directions. On the outer circumferential side of the belt layers 8, belt cover layers 9 are disposed. The belt cover layers 9 may be a full cover type, which covers the entire belt layer, or an edge cover type, which covers an end portion in the tire width direction of the belt layer, or both types may be combined. On the outer circumferential side of the belt cover layers 9, the tread portion 1 is disposed. The tread portion 1 includes a cap tread 10a and an undertread 10b. The rubber composition for a tire according to an embodiment of the present technology is preferably used in the tread portion 1 and/or the side portion 2 and more preferably used in the cap tread 10a and/or the undertread 10b.

In the rubber composition for a tire according to an embodiment of the present technology, a diene rubber consists of a styrene-butadiene rubber (A), a styrene-butadiene rubber (B), and a butadiene rubber. The styrene-butadiene rubber (A) has a glass transition temperature of from −75° C. to −50° C. and a weight average molecular weight lower than that of the styrene-butadiene rubber (B). The diene rubber including the styrene-butadiene rubber (A) reduces the viscosity of the rubber composition and can provide good forming processability.

The glass transition temperature (which may be hereinafter described as “Tg”) of the styrene-butadiene rubber (A) is preferably from −75° C. to −50° C. and more preferably from −70° C. to −55° C. In the present description, Tg can be measured as the temperature at the midpoint of the transition region on a thermogram obtained by differential scanning calorimetry (DSC) under conditions at a heating rate of 20° C./minute. In addition, when the diene rubber is an oil extended product, the Tg of the diene rubber is determined in a state of containing no oil-extending component (oil).

The weight average molecular weight of the styrene-butadiene rubber (A) is preferably from 300000 to 600000 and more preferably from 320000 to 580000. The styrene-butadiene rubber (A) having a weight average molecular weight within such a range further reduces the viscosity of the rubber composition and can provide good forming processability. In the present description, the weight average molecular weight can be a value obtained through measurement by gel permeation chromatography (GPC) and calibration with polystyrene.

The styrene-butadiene rubber (A) has a styrene content preferably of from 3 to 35 mass % and more preferably of from 5 to 30 mass %. With a styrene content of less than 3 mass %, wet performance may be reduced, and with a styrene content of more than 35 mass %, wear resistance performance may be reduced, both of which are not preferred. In the present description, the styrene content is a value measured by ¹H-NMR.

The styrene-butadiene rubber (A) has a vinyl content preferably of from 5 to 60% and more preferably of from 10 to 55%. With a vinyl content of less than 5%, wet performance may be reduced, and with a vinyl content of more than 60%, wear resistance performance may be reduced, both of which are not preferred. In the present description, the vinyl content is a value measured by ¹H-NMR.

The styrene-butadiene rubber (A) may be an unmodified styrene-butadiene rubber or a modified styrene-butadiene rubber. In the styrene-butadiene rubber, at least one terminal is preferably modified with a functional group. Examples of the functional group include an epoxy group, a carboxy group, an amino group, a hydroxy group, an alkoxy group, a silyl group, an alkoxysilyl group, an amide group, an oxysilyl group, a silanol group, an isocyanate group, an isothiocyanate group, a carbonyl group, and an aldehyde group. Among these, a functional group having a polyorganosiloxane structure or an aminosilane structure is preferred. The functional group having a polyorganosiloxane structure or an aminosilane structure provides good dispersibility of silica and can provide excellent wear resistance and wet performance.

The styrene-butadiene rubber (A) is in an amount of from 15 to 35 mass %, preferably of from 17 to 33 mass %, and more preferably of from 22 to 28 mass % in 100 mass % of the diene rubber. Containing the styrene-butadiene rubber (A) in an amount of less than 15 mass % would fail to provide a sufficient effect of improving forming processability by reducing viscosity of the rubber composition. In addition, when the styrene-butadiene rubber (A) exceeds 35 mass %, the balance of the styrene-butadiene rubber (B) and the butadiene rubber would not provide a sufficient effect of improving forming processability by reducing viscosity of the rubber composition.

The styrene-butadiene rubber (B) contained in the rubber composition for a tire has a weight average molecular weight that is 2 or more times the weight average molecular weight of the styrene-butadiene rubber (A). Containing the styrene-butadiene rubber (B) can improve wear resistance of the rubber composition. In addition, the Tg of the styrene-butadiene rubber (B) is higher than the Tg of the styrene-butadiene rubber (A), which can improve wet performance.

The weight average molecular weight of the styrene-butadiene rubber (B) is 2 or more times the weight average molecular weight of the styrene-butadiene rubber (A), and is preferably 600000 or more, more preferably from 700000 to 1600000, and even more preferably from 800000 to 1500000. The styrene-butadiene rubber (B) having a weight average molecular weight in such a range can further improve wear resistance of the rubber composition.

The Tg of the styrene-butadiene rubber (B) is preferably lower than −30° C., more preferably from −70° C. to −31° C., and even more preferably from −60° C. to −32° C. However, the Tg of the styrene-butadiene rubber (B) is preferably higher than the Tg of the styrene-butadiene rubber (A). The styrene-butadiene rubber (B) with a Tg in such a range can improve wet performance of the rubber composition and is preferred.

The styrene-butadiene rubber (B) has a styrene content preferably of from 5 to 50 mass % and more preferably of from 10 to 45 mass %. With a styrene content of less than 5 mass %, wet performance may be reduced, and with a styrene content of more than 50 mass %, wear resistance performance may be reduced, both of which are not preferred.

The styrene-butadiene rubber (B) has a vinyl content preferably of from 5 to 70% and more preferably of from 10 to 65%. With a vinyl content of less than 5%, wet performance may be reduced, and with a vinyl content of more than 70%, wear resistance performance may be reduced, both of which are not preferred.

The content of the styrene-butadiene rubber (B) is from once to twice by mass the content of the styrene-butadiene rubber (A) and is preferably from 15 to 70 mass %, more preferably from 25 to 60 mass %, even more preferably from 30 to 55 mass %, or still more preferably from 34 to 66 mass %, and further more preferably from 44 to 56 mass % in 100 mass % of the diene rubber. Containing the styrene-butadiene rubber (B) in an amount less than that of the styrene-butadiene rubber (A) would fail to provide a sufficient effect of improving wear resistance of the rubber composition. In addition, containing the styrene-butadiene rubber (B) in an amount more than twice the mass of the styrene-butadiene rubber (A) would fail to provide a sufficient effect of improving forming processability by reducing viscosity of the rubber composition.

The rubber composition for a tire contains the butadiene rubber in an amount of 30 mass % or more, preferably from 33 to 50 mass %, and preferably from 35 to 45 mass % in 100 mass % of the diene rubber. Containing the butadiene rubber in an amount of less than 30 mass % would reduce wear resistance. In addition, containing the butadiene rubber in an amount of 50 mass % or less facilitates good dispersibility of silica and can ensure good wet performance. The type of butadiene rubber is not particularly limited, and a butadiene rubber commonly used in a rubber composition for a tire can be used.

The rubber composition for a tire preferably does not contain natural rubber. The rubber composition not containing natural rubber tends to provide improved wet performance and is preferred. “Not containing natural rubber” means that natural rubber is not proactively blended in the rubber composition for a tire. For example, the rubber composition for a tire may contain a small amount of natural rubber as a result of blending a scrap material or the like of another rubber composition containing natural rubber for reuse, that is, recycling in the process, during preparation of the rubber composition for a tire. In the above case, natural rubber is preferably in an amount of from 0 to 5 mass % and more preferably of from 0 to 4 mass % in 100 mass % of the diene rubber.

In the rubber composition for a tire, silica is blended in an amount of from 50 to 150 parts by mass, preferably of from 60 to 140 parts by mass, and more preferably of from 70 to 130 parts by mass, per 100 parts by mass of the diene rubber. Blending silica can provide improved wet performance. Blending silica in an amount of less than 50 parts by mass would fail to provide a sufficient effect of improving wet performance. In addition, blending silica in an amount of more than 150 parts by mass would reduce forming processability.

Silica commonly used in a rubber composition for a tire is preferably used. For example, wet silica, dry silica, carbon-silica in which silica is supported on a carbon black surface (dual-phase filler), or silica surface-treated with a compound that is reactive or miscible with both silica and rubber, such as a silane coupling agent or polysiloxane, can be used. Among these, wet silica containing hydrous silicic acid as a main component is preferred.

In addition, blending a silane coupling agent together with silica improves dispersibility of silica and further improves wet performance, and thus is preferred. The type of silane coupling agent is not particularly limited but is preferably a sulfur-containing silane coupling agent. Examples can include bis(3-triethoxysilylpropyl)tetrasulfide, bis(3-triethoxysilylpropyl)trisulfide, bis(3-triethoxysilylpropyl)disulfide, bis(2-triethoxysilylethyl)tetrasulfide, bis(3-trimethoxysilylpropyl)tetrasulfide, bis(2-triethoxysilylethyl)tetrasulfide, mercaptosilane compounds exemplified in JP 2006-249069 A, such as 3-mercaptopropyltrimethoxysilane, 3-mercaptopropyldimethoxymethylsilane, 3-mercaptopropyldimethylmethoxysilane, 2-mercaptoethyltriethoxysilane, 3-mercaptopropyltriethoxysilane, and VP Si363 available from Evonik Co., 3-trimethoxysilylpropylbenzothiazole tetrasulfide, 3-triethoxysilylpropylbenzothiazolyl tetrasulfide, 3-triethoxysilylpropylmethacrylate monosulfide, 3-trimethoxysilylpropylmethacrylate monosulfide, 3-triethoxysilylpropyl-N,N-dimethylthiocarbamoyl tetrasulfide, 3-trimethoxysilylpropyl-N,N-dimethylthiocarbamoyl tetrasulfide, 2-triethoxysilylethyl-N,N-dimethylthiocarbamoyl tetrasulfide, bis(3-diethoxymethylsilylpropyl)tetrasulfide, dimethoxymethylsilylpropyl-N,N-dimethylthiocarbamoyl tetrasulfide, dimethoxymethylsilylpropylbenzothiazolyl tetrasulfide, 3-octanoylthiopropyltriethoxysilane, 3-propionylthiopropyltrimethoxysilane, vinyltrimethoxysilane, vinyltriethoxysilane, vinyltris(2-methoxyethoxy)silane, 3-glycidoxypropyltrimethoxysilane, 3-glycidoxypropylmethyldimethoxysilane, (β-(3,4-epoxycyclohexyl)ethyltrimethoxysilane, 3-aminopropyltrimethoxysilane, N-(β-aminoethyl)-γ-aminopropyltrimethoxysilane, and N-(β-aminoethyl)-γ-aminopropylmethyldimethoxysilane.

The silane coupling agent is blended in an amount preferably of from 3 to 20 mass % and more preferably of from 5 to 15 mass % per mass of silica. Blending the silane coupling agent in an amount of less than 3 mass % of the silica mass would fail to provide a sufficient effect of improving dispersibility of silica. In addition, blending the silane coupling agent in an amount of more than 20 mass % would tend to facilitate gelation of the diene rubber component and thus would fail to provide the desired effect.

Blending an additional filler besides silica in the rubber composition for a tire increases the strength of the rubber composition and can ensure tire durability. Examples of the additional filler can include an inorganic filler, such as carbon black, calcium carbonate, magnesium carbonate, talc, clay, alumina, aluminum hydroxide, titanium oxide, calcium sulfate, mica, and barium sulfate; and an organic filler, such as cellulose, lecithin, lignin, and dendrimer.

Among these, blending carbon black provides excellent strength to the rubber composition and can improve wear resistance. As the carbon black, carbon black, such as furnace black, acetylene black, thermal black, channel black, or graphite, may be blended. Among these, furnace black is preferred, and specific examples include SAF (Super Abrasion Furnace), ISAF (Intermediate Super Abrasion Furnace), ISAF-HS (Intermediate Super Abrasion Furnace-High Structure), ISAF-LS (Intermediate Super Abrasion Furnace-Low Structure), IISAF-HS (Intermediate Intermediate Super Abrasion Furnace-High Structure), HAF (High Abrasion Furnace), HAF-HS (High Abrasion Furnace-High Structure), HAF-LS (High Abrasion Furnace-Low Structure) and FEF (Fast Extruding Furnace). These carbon blacks can be used individually or in combination of two or more types thereof. In addition, a surface-treated carbon black obtained by chemically modifying a carbon black of these with various acid compounds can also be used.

In the rubber composition for a tire, a thermoplastic resin is blended in an amount of from 10 to 80 parts by mass, preferably of from 12 to 78 parts by mass, and more preferably of from 15 to 75 parts by mass, per 100 parts by mass of the diene rubber. Blending the thermoplastic resin can improve wear resistance and can suppress a decrease in wear resistance even when the styrene-butadiene rubber (A) has a low weight average molecular weight. In addition, the thermoplastic resin functions like a plasticizer, thus improving forming processability, increasing Tg of the rubber composition, and improving wet performance. Blending the thermoplastic resin in an amount of less than 10 parts by mass would fail to provide a sufficient effect of improving wear resistance. Blending the thermoplastic resin in an amount of more than 80 parts by mass would rather reduce the effect of improving wear resistance.

The thermoplastic resin is a resin usually blended in a rubber composition for a tire, has a molecular weight of from about several hundreds to several thousands, and has a function of imparting adhesiveness to the rubber composition for a tire. The thermoplastic resin is preferably at least one selected from the group consisting of a resin composed of at least one selected from a terpene, a modified terpene, a rosin, a rosin ester, a C5 component, and a C9 component, and a resin with at least some of double bonds of the resin being hydrogenated. Examples of the resin include a natural resin, such as a terpene resin, a modified terpene resin, a rosin resin, and a rosin ester resin; and a synthetic resin, such as a petroleum resin composed of a C5 component and/or a C9 component, a coal resin, a phenolic resin, and a xylene-based resin.

Examples of the terpene resin include α-pinene resin, β-pinene resin, limonene resin, hydrogenated limonene resin, dipentene resin, terpene phenol resin, terpene styrene resin, an aromatic modified terpene resin, and a hydrogenated terpene resin. Examples of the rosin resin include a modified rosin, such as gum rosin, tall oil rosin, wood rosin, hydrogenated rosin, disproportionated rosin, polymerized rosin, maleinized rosin, and fumarized rosin; an ester derivative of these rosins, such as a glycerin ester, a pentaerythritol ester, a methyl ester, and a triethylene glycol ester; and a rosin-modified phenol resin.

Examples of the petroleum resin include an aromatic hydrocarbon resin, or alternatively, a saturated or unsaturated aliphatic hydrocarbon resin. Examples include a C5 petroleum resin (an aliphatic petroleum resin obtained by polymerizing fractions of isoprene, 1,3-pentadiene, cyclopentadiene, methylbutene, pentene, and/or the like), a C9 petroleum resin (an aromatic petroleum resin obtained by polymerizing fractions of α-methylstyrene, o-vinyltoluene, m-vinyltoluene, p-vinyltoluene, and/or the like), and a C5C9 copolymerized petroleum resin.

The thermoplastic resin has a glass transition temperature preferably of from 40° C. to 120° C., more preferably of from 45° C. to 115° C., and even more preferably of from 50° C. to 110° C. The thermoplastic resin with a glass transition temperature of 40° C. or higher improves dry grip performance and is preferred. In addition, the thermoplastic resin with a glass transition temperature of 120° C. or lower improves wear resistance and is preferred. The glass transition temperature of the thermoplastic resin can be measured by the method described above.

The rubber composition for a tire preferably contains a liquid polymer. Blending a liquid polymer improves wear resistance. The liquid polymer is blended in an amount preferably of from 0 to 30 parts by mass and more preferably of from 3 to 25 parts by mass per 100 parts by mass of the diene rubber. Blending the liquid polymer in an amount of more than 30 parts by mass would reduce wet performance. Examples of the liquid polymer can include liquid polybutene, liquid polyisobutene, liquid polyisoprene, liquid polybutadiene, liquid poly(α-olefin), liquid ethylene-propylene copolymer, and liquid ethylene-butylene copolymer.

Various compounding agents commonly used in a rubber composition for a tire can be blended in addition to the above components in the rubber composition for a tire according to an ordinary method. The compounding agents include a vulcanization or crosslinking agent, a vulcanization accelerator, an anti-aging agent, a processing aid, a plasticizer, and a thermosetting resin. Such a compounding agent can be kneaded to form a rubber composition by a common method and can be used for vulcanization or crosslinking. The blended amount of the compounding agent can be a common blended amount known in the art as long as the present technology are not hindered. The rubber composition for a tire can be prepared by mixing the above components using a known rubber kneading machine, such as, a Banbury mixer, a kneader, or a roll mill.

The rubber composition for a tire is suitable for forming a tread portion and/or a side portion of a tire and especially suitable for forming a tread portion of a high-performance tire. The resulting tire has high levels of wear resistance and wet performance in a compatible manner, and high quality tires with good forming processability can be stably produced.

Hereinafter, the present technology will be further described by examples. However, the scope of the present technology is not limited to these examples.

### Examples

In preparing 33 types of rubber compositions for a tire (Standard Example, Examples 1 to 20, and Comparative Examples 1 to 12) having the common additive formulation shown in Table 6 and composed of the compositions shown in Tables 1 to 5, components other than sulfur and vulcanization accelerators were each weighed and kneaded in a 1.7-L sealed Banbury mixer for 5 minutes. Then, its master batch was discharged outside the mixer and cooled at room temperature. This master batch was placed in the same Banbury mixer, sulfur and vulcanization accelerators were added and mixed, and a rubber composition for a tire was obtained. In the tables, SBR (B)-1 and SBR (B)-2 are oil extended products containing 37.5 parts by mass of an oil-extending component, and thus the blended amount without the oil-extending component is shown in parentheses in the lower line. In addition, the additive formulation in Table 6 is described by values in parts by mass per 100 parts by mass of the diene rubbers listed in Tables 1 to 5.

Mooney viscosity of the rubber compositions obtained above was measured by the method below. In addition, the rubber compositions for a tire were each vulcanized at 160° C. for 20 minutes in a mold with a predetermined shape, and evaluation samples were produced. Using the resulting evaluation samples, dynamic viscoelasticity (loss tangent tan δ at 0° C.) and wear resistance were measured by the methods below.

### Mooney Viscosity (ML₁₊₄)

Mooney viscosity of the rubber compositions for a tire was measured in accordance with JIS (Japanese Industrial Standard) K 6300 with a Mooney viscometer using an L-type rotor (38.1 mm in diameter, 5.5 mm in thickness) under conditions of a preheating time of 1 minute, a rotor rotation time of 4 minutes, 100° C., and 2 rpm. The obtained results are presented in the rows of “Forming processability (viscosity)” of Tables 1 to 5 as index values with a value of Standard Example set at 100. A smaller value of this index value means lower viscosity and superior processability.

### Dynamic Viscoelasticity (Loss Tangent tan δ at 0° C.)

Dynamic viscoelasticity of the evaluation samples of the rubber compositions for a tire was measured using a viscoelasticity spectrometer available from Iwamoto Seisakusho Co., Ltd. under conditions of an elongation deformation strain of 10±2%, a vibration frequency of 20 Hz, and a temperature of 0° C., and the loss tangents tan δ at 0° C. were determined. The obtained results are presented in the rows of “Wet performance” of Tables 1 to 5 as index values with a value of Standard Example set at 100. A larger value of this index value means a larger tan δ at 0° C. and superior wet performance.

### Wear Resistance

The amounts of wear of the resulting evaluation samples of the rubber compositions for a tire were measured in accordance with JIS K6264 using a Lambourn abrasion test machine (available from Iwamoto Seisakusho, Co., Ltd.) under conditions of a load of 15.0 kg (147.1 N) and a slip rate of 25%. A reciprocal of each obtained result was calculated and listed in the row of “Wear resistance” of Tables 1 to 5 as an index value with a reciprocal of the amount of wear of Standard Example set at 100. A larger value of this index value means a smaller amount of wear and superior wear resistance.

TABLE 1

| | | Standard | Example | Example | Example | Example | Example | Example |
|---|---|---|---|---|---|---|---|---|
| | | Example | 1 | 2 | 3 | 4 | 5 | 6 |
| SBR (A)-1 | Parts by | 30 | 30 | 17 | 22 | 28 | 33 | 30 |
| | mass | | | | | | | |
| SBR (B)-1 | Parts by | 41.3 (30) | 41.3 (30) | 45.4 (33) | 52.3 (38) | 44 (32) | 48.1 (35) | 41.3 (30) |
| | mass | | | | | | | |
| BR | Parts by | 40 | 40 | 50 | 40 | 40 | 32 | 40 |
| | mass | | | | | | | |
| CB | Parts by | 10 | 10 | 10 | 10 | 10 | 10 | 10 |
| | mass | | | | | | | |
| Silica | Parts by | 100 | 100 | 100 | 100 | 100 | 100 | 53 |
| | mass | | | | | | | |
| Thermoplastic | Parts by | 5 | 25 | 25 | 25 | 25 | 25 | 25 |
| resin-1 | mass | | | | | | | |
| Aroma oil | Parts by | 80 | 60 | 60 | 60 | 60 | 60 | 60 |
| | mass | | | | | | | |
| Coupling | Parts by | 10 | 10 | 10 | 10 | 10 | 10 | 5.3 |
| agent | mass | | | | | | | |
| Ratio SBR (B)/SBR (A) (—) | | 1.0 | 1.0 | 1.9 | 1.7 | 1.1 | 1.1 | 1.0 |
| Forming | Index | 100 | 95 | 92 | 93 | 93 | 97 | 82 |
| processability | value | | | | | | | |
| (viscosity) | | | | | | | | |
| Wear | Index | 100 | 120 | 130 | 125 | 122 | 118 | 118 |
| resistance | value | | | | | | | |
| performance | | | | | | | | |
| Wet | Index | 100 | 110 | 105 | 110 | 108 | 115 | 104 |
| performance | value | | | | | | | |

TABLE 2

| | | Example | Example | Example | Example | Example | Example | Example |
|---|---|---|---|---|---|---|---|---|
| | | 7 | 8 | 9 | 10 | 11 | 12 | 13 |
| SBR (A)-1 | Parts by | 30 | 30 | 30 | 30 | 30 | 30 | 30 |
| | mass | | | | | | | |
| SBR (B)-1 | Parts by | 41.3 (30) | 41.3 (30) | 41.3 (30) | 41.3 (30) | 41.3 (30) | 41.3 (30) | 41.3 (30) |
| | mass | | | | | | | |
| BR | Parts by | 40 | 40 | 40 | 40 | 40 | 40 | 40 |
| | mass | | | | | | | |
| CB | Parts by | 10 | 10 | 10 | 10 | 10 | 10 | 10 |
| | mass | | | | | | | |
| Silica | Parts by | 80 | 120 | 147 | 100 | 100 | 100 | 100 |
| | mass | | | | | | | |
| Thermoplastic | Parts by | 25 | 25 | 25 | 11 | 20 | 40 | 60 |
| resin-1 | mass | | | | | | | |
| Aroma oil | Parts by | 60 | 60 | 60 | 74 | 65 | 45 | 25 |
| | mass | | | | | | | |
| Coupling | Parts by | 8 | 12 | 14.7 | 10 | 10 | 10 | 10 |
| agent | mass | | | | | | | |
| Ratio SBR (B)/SBR (A) (—) | | 1.0 | 1.0 | 1.0 | 1.0 | 1.0 | 1.0 | 1.0 |
| Forming | Index | 87 | 92 | 98 | 98 | 96 | 97 | 98 |
| processability | value | | | | | | | |
| (viscosity) | | | | | | | | |
| Wear | Index | 123 | 119 | 115 | 103 | 110 | 123 | 128 |
| resistance | value | | | | | | | |
| performance | | | | | | | | |
| Wet | Index | 106 | 109 | 111 | 103 | 109 | 112 | 115 |
| performance | value | | | | | | | |

TABLE 3

| | | Example | Example | Example | Example | Example | Example | Example |
|---|---|---|---|---|---|---|---|---|
| | | 14 | 15 | 16 | 17 | 18 | 19 | 20 |
| SBR (A)-1 | Parts by | 30 | 30 | | | 30 | 30 | 30 |
| | mass | | | | | | | |
| SBR (A)-2 | Parts by | | | 30 | | | | |
| | mass | | | | | | | |
| SBR (A)-3 | Parts by | | | | 30 | | | |
| | mass | | | | | | | |
| SBR (B)-1 | Parts by | 41.3 (30) | 41.3 (30) | 41.3 (30) | 41.3 (30) | | 41.3 (30) | 41.3 (30) |
| | mass | | | | | | | |
| SBR (B)-2 | Parts by | | | | | 41.3 (30) | | |
| | mass | | | | | | | |
| BR | Parts by | 40 | 40 | 40 | 40 | 40 | 40 | 40 |
| | mass | | | | | | | |
| CB | Parts by | 10 | 10 | 10 | 10 | 10 | 10 | 10 |
| | mass | | | | | | | |
| Silica | Parts by | 100 | 100 | 100 | 100 | 100 | 100 | 100 |
| | mass | | | | | | | |
| Thermoplastic | Parts by | 79 | | 25 | 25 | 25 | | |
| resin-1 | mass | | | | | | | |
| Thermoplastic | Parts by | | 25 | | | | | |
| resin-2 | mass | | | | | | | |
| Thermoplastic | Parts by | | | | | | 25 | |
| resin-3 | mass | | | | | | | |
| Thermoplastic | Parts by | | | | | | | 25 |
| resin-4 | mass | | | | | | | |
| Aroma oil | Parts by | 6 | 60 | 60 | 60 | 60 | 85 | 85 |
| | mass | | | | | | | |
| Coupling | Parts by | 10 | 10 | 10 | 10 | 10 | 10 | 10 |
| agent | mass | | | | | | | |
| Ratio SBR (B)/SBR (A) (—) | | 1.0 | 1.0 | 1.0 | 1.0 | 1.0 | 1.0 | 1.0 |
| Forming | Index | 99 | 95 | 96 | 95 | 98 | 95 | 95 |
| processability | value | | | | | | | |
| (viscosity) | | | | | | | | |
| Wear | Index | 130 | 120 | 125 | 102 | 102 | 120 | 119 |
| resistance | value | | | | | | | |
| performance | | | | | | | | |
| Wet | Index | 116 | 120 | 105 | 105 | 112 | 107 | 112 |
| performance | value | | | | | | | |

TABLE 4-1

| | | Comparative | Comparative | Comparative |
|---|---|---|---|---|
| | | Example 1 | Example 2 | Example 3 |
| SBR (A)-1 | Parts by | 13 | 36 | 30 |
| | mass | | | |
| SBR (B)-1 | Parts by | 48.1 | 50.9 | 41.3 |
| | mass | (35) | (37) | (30) |
| BR | Parts by | 52 | 27 | 40 |
| | mass | | | |
| CB | Parts by | 10 | 10 | 10 |
| | mass | | | |
| Silica | Parts by | 100 | 100 | 48 |
| | mass | | | |
| Thermoplastic | Parts by | 25 | 25 | 25 |
| resin-1 | mass | | | |
| Aroma oil | Parts by | 58 | 57 | 60 |
| | mass | | | |
| Coupling | Parts by | 10 | 10 | 4.8 |
| agent | mass | | | |
| Ratio SBR (B)/SBR (A) (—) | | 2.7 | 1.0 | 1.0 |
| Forming | Index value | 102 | 105 | 80 |
| processability | | | | |
| (viscosity) | | | | |
| Wear | Index value | 131 | 103 | 108 |
| resistance | | | | |
| performance | | | | |
| Wet | Index value | 95 | 112 | 99 |
| performance | | | | |

TABLE 4-2

| | | Comparative | Comparative | Comparative |
|---|---|---|---|---|
| | | Example 4 | Example 5 | Example 6 |
| SBR (A)-1 | Parts by | 30 | 30 | 30 |
| | mass | | | |
| SBR (B)-1 | Parts by | 41.3 | 41.3 | 41.3 |
| | mass | (30) | (30) | (30) |
| BR | Parts by | 40 | 40 | 40 |
| | mass | | | |
| CB | Parts by | 10 | 10 | 10 |
| | mass | | | |
| Silica | Parts by | 152 | 100 | 100 |
| | mass | | | |
| Thermoplastic | Parts by | 25 | 8 | 82 |
| resin-1 | mass | | | |
| Aroma oil | Parts by | 60 | 77 | 3 |
| | mass | | | |
| Coupling | Parts by | 15.2 | 10 | 10 |
| agent | mass | | | |
| Ratio SBR (B)/SBR (A) (—) | | 1.0 | 1.0 | 1.0 |
| Forming | Index value | 101 | 100 | 102 |
| processability | | | | |
| (viscosity) | | | | |
| Wear | Index value | 105 | 105 | 126 |
| resistance | | | | |
| performance | | | | |
| Wet | Index value | 112 | 103 | 117 |
| performance | | | | |

TABLE 5-1

| | | Comparative | Comparative | Comparative |
|---|---|---|---|---|
| | | Example 7 | Example 8 | Example 9 |
| SBR (A)-1 | Parts by | 13 | 25 | 30 |
| | mass | | | |
| SBR (A)-2 | Parts by | | | 30 |
| | mass | | | |
| SBR (B)-1 | Parts by | 35.8 | 66 | |
| | mass | (26) | (48) | |
| SBR (B)-2 | Parts by | | | |
| | mass | | | |
| BR | Parts by | 61 | 27 | 40 |
| | mass | | | |
| CB | Parts by | 10 | 10 | 10 |
| | mass | | | |
| Silica | Parts by | 100 | 100 | 100 |
| | mass | | | |
| Thermoplastic | Parts by | 25 | 25 | 25 |
| resin-1 | mass | | | |
| Aroma oil | Parts by | 62 | 53 | 71 |
| | mass | | | |
| Coupling | Parts by | 10 | 10 | 10 |
| agent | mass | | | |
| Ratio SBR (B)/SBR (A) (—) | | 2.0 | 1.9 | — |
| Forming | Index value | 98 | 105 | 90 |
| processability | | | | |
| (viscosity) | | | | |
| Wear | Index value | 131 | 95 | 93 |
| resistance | | | | |
| performance | | | | |
| Wet | Index value | 80 | 112 | 75 |
| performance | | | | |

TABLE 5-2

| | | Comparative | Comparative | Comparative |
|---|---|---|---|---|
| | | Example 10 | Example 11 | Example 12 |
| SBR (A)-1 | Parts by | | 34 | 20 |
| | mass | | | |
| SBR (A)-2 | Parts by | | | |
| | mass | | | |
| SBR (B)-1 | Parts by | 41.3 | 41.3 | 61.9 |
| | mass | (30) | (30) | (45) |
| SBR (B)-2 | Parts by | 41.3 | | |
| | mass | (30) | | |
| BR | Parts by | 40 | 36 | 35 |
| | mass | | | |
| CB | Parts by | 10 | 10 | 10 |
| | mass | | | |
| Silica | Parts by | 100 | 100 | 100 |
| | mass | | | |
| Thermoplastic | Parts by | 25 | 25 | 25 |
| resin-1 | mass | | | |
| Aroma oil | Parts by | 60 | 60 | 54 |
| | mass | | | |
| Coupling | Parts by | 10 | 10 | 10 |
| agent | mass | | | |
| Ratio SBR (B)/SBR (A) (—) | | — | 0.9 | 2.3 |
| Forming | Index value | 120 | 98 | 105 |
| processability | | | | |
| (viscosity) | | | | |
| Wear | Index value | 103 | 98 | 104 |
| resistance | | | | |
| performance | | | | |
| Wet | Index value | 115 | 102 | 102 |
| performance | | | | |

Types of raw materials used in Tables 1 to 5 are shown below.
SBR (A)-1: terminal-modified styrene-butadiene rubber having a polyorganosiloxane structure, NS612 available from ZEON CORPORATION, glass transition temperature −61° C., weight average molecular weight 450000, styrene content 15 mass %, vinyl content 30%, non-oil extended product.
SBR (A)-2: terminal-modified styrene-butadiene rubber having a polyorganosiloxane structure obtained by the polymerization method below, glass transition temperature −70° C., weight average molecular weight 450000, styrene content 18 mass %, vinyl content 13%, non-oil extended product.
SBR (A)-3: styrene-butadiene rubber, Tufdene 1000 available from Asahi Kasei Corporation, glass transition temperature −73° C., weight average molecular weight 290000, styrene content 18 mass %, vinyl content 12%, non-oil extended product.
SBR (B)-1: modified styrene-butadiene rubber, Tufdene E581 available from Asahi Kasei Corporation, glass transition temperature −34° C., weight average molecular weight 1260000, styrene content 36 mass %, vinyl content 42%, oil extended product containing 37.5 parts by mass of oil-extending component.
SBR (B)-2: modified styrene-butadiene rubber, Tufdene E680 available from Asahi Kasei Corporation, glass transition temperature −25° C., weight average molecular weight 1470000, styrene content 36 mass %, vinyl content 57%, oil extended product containing 37.5 parts by mass of oil-extending component.
BR: butadiene rubber, Nipol BR1220 available from ZEON CORPORATION, glass transition temperature −105° C., weight average molecular weight 460000.
Carbon black: DASHBLACK N220 available from OCI Company Ltd.
Silica: ZEOSIL 195MP available from Solvay
Thermoplastic resin-1: aromatic modified terpene resin, YS Resin TO-125 available from Yasuhara Chemical Co., Ltd., glass transition temperature 79° C.
Thermoplastic resin-2: aromatic modified terpene resin, YS Resin TO-105 available from Yasuhara Chemical Co., Ltd., glass transition temperature 57° C.
Resin-3: C9 resin, Neopolymer S100 available from ENEOSE Corporation, glass transition temperature 58° C.
Resin-4: C5C9 resin, Neopolymer 170S available from ENEOSE Corporation, glass transition temperature 105° C.
Oil: Extract No. 4S available from Shell Lubricants Japan K.K.
Coupling agent: silane coupling agent, Si69 available from Evonik-Degussa GmbH

### Polymerization Method of SBR (A)-2

In a 800-mL ampoule bottle purged with nitrogen, 70.0 g of cyclohexane and 0.77 mmol of tetramethylethylenediamine were added, and 7.69 mmol of n-butyllithium was further added. Then, 27.9 g of isoprene and 2.1 g of styrene were slowly added, the mixture was reacted for 120 minutes in the ampoule bottle at a temperature of 50° C., and a polymer block having an active terminal was obtained.

In an autoclave equipped with a stirrer, 4000 g of cyclohexane, 1.50 mmol of tetramethylethylenediamine, 445 g of 1,3-butadiene, and 155 g of styrene were added in a nitrogen atmosphere. Then, the entire amount of polymer block having an active terminal obtained above was added, and polymerization was initiated at 50° C. 10 minutes after the polymerization was initiated, 355 g of 1,3-butadiene and 40 g of styrene were continuously added over 60 minutes. The maximum temperature during the polymerization reaction was 75° C. After completion of the continuous addition, the polymerization reaction was continued for another 10 minutes. After the polymer conversion rate was confirmed to have reached in the range of from 95% to 100%, 2.44 g of polyorganosiloxane represented by Formula (I) below was added in a state of a xylene solution with a 40 mass % concentration, and the mixture was reacted for 30 minutes. Then, methanol in an amount equivalent to twice the molar amount of n-butyllithium used was added as a polymerization terminator, and a solution containing a conjugated diene rubber was obtained. Irganox 1520L (available from BASF) was added to this solution as an anti-aging agent in an amount of 0.15 parts per 100 parts of the conjugated diene rubber, and then the solvent was removed by steam stripping. The remaining mixture was vacuum-dried at 60° C. for 24 hours, and a solid conjugated diene rubber (SBR (A)-2) was obtained.

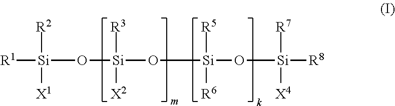

In Formula (I) above, m is 80, k is 120, X¹, X⁴, R¹ to R³ and R⁵ to R⁸ are methyl groups, and X² is a group represented by Formula (II) below (where * represents a bonding position).

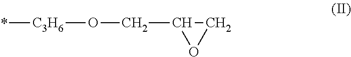

TABLE 6
Common additive formulation

| | | |
|---|---|---|
| Anti-aging agent | 3.0 | parts by mass |
| Wax | 1.0 | part by mass |
| Zinc oxide | 2.0 | parts by mass |
| Stearic acid | 1.0 | part by mass |
| Vulcanization accelerator-1 | 2.0 | parts by mass |
| Vulcanization accelerator-2 | 1.0 | part by mass |
| Sulfur | 1.5 | parts by mass |

Types of raw materials used in Table 6 are shown below.
Anti-aging agent: VULANOX 4020 available from LANXESS AG
Wax: OZOACE-0015A available from NIPPON SEIRO Co., Ltd.
Zinc oxide: Zinc Oxide III, available from Seido Chemical Industry Co., Ltd.
Stearic acid: beads stearic acid available from NOF Corporation
Vulcanization accelerator-1: NOCCELER CZ-G available from Ouchi Shinko Chemical Industrial Co., Ltd.
Vulcanization accelerator-2: Soxinol D-G available from Sumitomo Chemical Co., Ltd.
Sulfur: SULFAX 5 available from Tsurumi Chemical Industry Co., Ltd.

As can be seen from Tables 1 to 3, the rubber compositions for a tire in Examples 1 to 20 were confirmed to have excellent wear resistance and wet performance and also have excellent forming processability (Mooney viscosity).

As can be seen from Table 4, the rubber composition for a tire in Comparative Example 1 contains less than 15 parts by mass of SBR (A) with an SBR (B)/SBR (A) mass ratio of more than 2, resulting in low wet performance and an inability to improve the forming processability (Mooney viscosity).

The rubber composition for a tire in Comparative Example 2 contains more than 35 parts by mass of SBR (A) and thus cannot improve forming processability (Mooney viscosity).

The rubber composition for a tire in Comparative Example 3 contains less than 50 parts by mass of silica and thus cannot improve wet performance.

The rubber composition for a tire in Comparative Example 4 contains more than 150 parts by mass of silica and thus cannot improve forming processability (Mooney viscosity).

The rubber composition for a tire in Comparative Example 5 contains less than 10 parts by mass of the thermoplastic resin and thus cannot improve forming processability (Mooney viscosity).

The rubber composition for a tire in Comparative Example 6 contains more than 80 parts by mass of the thermoplastic resin and thus cannot improve forming processability (Mooney viscosity).

As can be seen from Table 5, the rubber composition for a tire in Comparative Example 7 contains less than 15 parts by mass of SBR (A) and thus cannot improve wear resistance.

The rubber composition for a tire in Comparative Example 8 contains less than 30 parts by mass of the butadiene rubber and thus cannot improve forming processability (Mooney viscosity) and wear resistance.

The rubber composition for a tire in Comparative Example 9 does not contain SBR (B) and thus cannot improve wear resistance and wet performance.

The rubber composition for a tire in Comparative Example 10 does not contain SBR (A) and thus deteriorates forming processability (Mooney viscosity).

The rubber composition for a tire in Comparative Example 11 has a mass ratio of SBR (B)/SBR (A) of less than 1 and thus cannot improve wear resistance.

The rubber composition for a tire in Comparative Example 12 has a mass ratio of SBR (B)/SBR (A) of more than 2 and thus cannot improve forming processability (Mooney viscosity).

The present disclosure includes the following embodiments of the technology.
Technology [1] A rubber composition for a tire, the rubber composition containing from 50 to 150 parts by mass of silica and from 10 to 80 parts by mass of a thermoplastic resin that are blended per 100 parts by mass of a diene rubber consisting of a styrene-butadiene rubber (A), a styrene-butadiene rubber (B), and a butadiene rubber,
   in 100 mass % of the diene rubber,
   the butadiene rubber being in an amount of 30 mass % or more,
   the styrene-butadiene rubber (A) being in an amount of from 15 to 35 mass %,
   the styrene-butadiene rubber (B) being in an amount from once to twice a mass of the styrene-butadiene rubber (A),
   the styrene-butadiene rubber (A) having a glass transition temperature of from −75° C. to −50° C., and
   the styrene-butadiene rubber (B) having a weight average molecular weight that is 2 or more times a weight average molecular weight of the styrene-butadiene rubber (A).
Technology [2] The rubber composition for a tire according to Technology [1], in which the styrene-butadiene rubber (A) has a weight average molecular weight of from 300000 to 600000.
Technology [3] The rubber composition for a tire according to Technology [1] or [2], in which the styrene-butadiene rubber (B) has a glass transition temperature lower than −30° C.
Technology [4] The rubber composition for a tire according to any of Technologies [1] to [3], in which the thermoplastic resin is at least one selected from the group consisting of a resin composed of at least one selected from a terpene, a modified terpene, a rosin, a rosin ester, a C5 component, and a C9 component, and a resin with at least some of double bonds of the resin being hydrogenated, and the thermoplastic resin has a glass transition temperature of from 40° C. to 120° C.
Technology [5] The rubber composition for a tire according to any of Technologies [1] to [4], further containing a liquid polymer.
Technology [6] A tire including a tread portion made of the rubber composition for a tire according to any of Technologies [1] to [5].

1. A rubber composition for a tire, the rubber composition comprising from 50 to 150 parts by mass of silica and from 10 to 80 parts by mass of a thermoplastic resin that are blended per 100 parts by mass of a diene rubber consisting of a styrene-butadiene rubber (A), a styrene-butadiene rubber (B), and a butadiene rubber,
in 100 mass % of the diene rubber,
the butadiene rubber being in an amount of 30 mass % or more,
the styrene-butadiene rubber (A) being in an amount of from 15 to 35 mass %,
the styrene-butadiene rubber (B) being in an amount from once to twice a mass of the styrene-butadiene rubber (A),
the styrene-butadiene rubber (A) having a glass transition temperature of from −75° C. to −50° C., and
the styrene-butadiene rubber (B) having a weight average molecular weight that is 2 or more times a weight average molecular weight of the styrene-butadiene rubber (A).

2. The rubber composition for a tire according to claim 1, wherein the styrene-butadiene rubber (A) has a weight average molecular weight of from 300000 to 600000.

3. The rubber composition for a tire according to claim 1, wherein the styrene-butadiene rubber (B) has a glass transition temperature lower than −30° C.

4. The rubber composition for a tire according to claim 1, wherein the thermoplastic resin is at least one selected from the group consisting of a resin consisting of at least one selected from a terpene, a modified terpene, a rosin, a rosin ester, a C5 component, and a C9 component, and a resin with at least some of double bonds of the resin being hydrogenated, and the thermoplastic resin has a glass transition temperature of from 40° C. to 120° C.

5. The rubber composition for a tire according to claim 1, further comprising a liquid polymer.

6. A tire comprising a tread portion made of the rubber composition for a tire according to claim 1.

7. The rubber composition for a tire according to claim 2, wherein the styrene-butadiene rubber (B) has a glass transition temperature lower than −30° C.

8. The rubber composition for a tire according to claim 2, wherein the thermoplastic resin is at least one selected from the group consisting of a resin consisting of at least one selected from a terpene, a modified terpene, a rosin, a rosin ester, a C5 component, and a C9 component, and a resin with at least some of double bonds of the resin being hydrogenated, and the thermoplastic resin has a glass transition temperature of from 40° C. to 120° C.

9. The rubber composition for a tire according to claim 2, further comprising a liquid polymer.

10. A tire comprising a tread portion made of the rubber composition for a tire according to claim 2.
